(19) United States
(12) Patent Application Publication
(10) Pub. No.: US 2017/0335812 A1
(43) Pub. Date: Nov. 23, 2017

(54) AUTO DRAIN SYSTEM FOR VACUUM SIDE FUEL WATER SEPARATORS

(71) Applicants: Hui XIAO, Wuhan, Hubei (CN); Cummins Filtration IP, Inc., Columbus, IN (US)

(72) Inventors: Hui Xiao, Wuhan (CN); Penghua Hou, Shanghai (CN); Hanhao Li, Beijing (CN); Zhisong Liu, Shanghai (CN); Christopher E. Holm, Madison, WI (US); Peter K. Herman, Stoughton, WI (US); Robert A. Bannister, Ames, IA (US); Kevin C. South, Cookeville, TN (US); Feng Qian, Wuhan (CN); Weian Wu, Beijing (CN); Chirag D. Parikh, Madison, WI (US)

(73) Assignee: Cummins Filtration IP, Inc., Columbus, IN (US)

(21) Appl. No.: 15/513,832

(22) PCT Filed: Sep. 22, 2015
(86) PCT No.: PCT/CN2015/090281

§ 371 Date: Mar. 23, 2017

(30) Foreign Application Priority Data
Sep. 26, 2014 (CN) 201410504844.X
Sep. 26, 2014 (CN) 201420561634.X

(51) Int. Cl. F02M 37/22; B01D 36/00

(52) U.S. Cl. CPC F02M 37/221; B01D 36/005

(57) ABSTRACT

Fuel filtration systems having an automatic drain assembly for water that accumulates in the filter housing are described. The filtration system includes a filter media that is configured to remove particulate matter and dispersed water contained within the fuel. The water is drained to a drain reservoir within the filter housing where the water collects. When the water reaches a threshold level, a controller initiates a warning to the engine operator, such as a dashboard light, that instructs the operator to shut the engine off. When the engine is shut off, the collected water is drained through a valve of the automatic drain assembly. In some arrangements, the automatic drain assembly can be retrofitted to existing fuel filtration systems thereby reducing the cost of fitting the automatic drain assembly to existing internal combustion engines.

### TECHNICAL FIELD

The present disclosure relates generally to fuel water separators for use with internal combustion engines.

### BACKGROUND

Internal combustion engines generally require clean fuel for efficient operation. Contaminants, such as dirt and water, in fuel can damage the internal combustion engines and decrease the efficiency of the internal combustion engines. Accordingly, most internal combustion engines utilize fuel filtration systems. The fuel filtration systems remove various particulate and water from fuel prior to delivering the fuel to an external system, such as an internal combustion engine. The water separated from the fuel is often stored in the filter system housing until it is periodically drained from the housing through a valve. The valve is typically a manual valve operated by an operator of the internal combustion engine (e.g., via a specialized tool, via a command initiated by the user, etc.). However, some operators allow the internal combustion engine to run with too much water in the housing, which potentially allows water to pass through the filtration system and into the internal combustion engine.

### SUMMARY

One embodiment relates to a fuel filtration system configured to provide filtered fuel to an internal combustion engine. The fuel filtration system includes a filter housing having an inlet, an outlet, a filter media, and a drain reservoir positioned at a bottom of the filter housing. The fuel filtration system further includes an automatic drain assembly removably coupled to the filter housing. The automatic drain assembly includes a drain assembly housing and a water inlet that extends into the filter housing. The automatic drain assembly further includes a valve coupled to the drain assembly housing. The automatic drain assembly includes a water in fuel sensor coupled to the valve. The automatic drain assembly includes a controller configured to open and close the valve based at least in part on a water in fuel feedback signal of the water in fuel sensor without direct instruction from an operator of the internal combustion engine.

Another embodiment relates to an automatic drain system for a fuel filtration system of an internal combustion engine. The automatic drain system includes a drain housing and a water inlet configured to extend into a filter housing of the fuel filtration system. The automatic drain system includes a valve coupled to the drain assembly housing. The automatic drain system further includes a water in fuel sensor coupled to the valve. The automatic drain system includes a controller configured to open and close the valve based at least in part on a water in fuel feedback signal of the water in fuel sensor without direct instruction from an operator of the internal combustion engine.

A further embodiment relates to a method of automatically draining water separated from fuel by a fuel filtration system of an internal combustion engine via an automatic drain assembly. The method includes monitoring, by a controller of the automatic drain assembly, a water in fuel sensor of the automatic drain assembly. The method further includes determining, by the controller, that a high water level exists within a filter assembly housing of the fuel filtration system. The method includes opening, by the controller, a valve of the automatic drain assembly without direct instruction from an operator of the internal combustion engine, wherein when the valve is open, the water is allowed to drain out of the filter assembly housing through a drain of a drain assembly housing. The method further includes closing, by the controller, the valve.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a schematic overview of a fuel delivery system is shown according to an exemplary embodiment.

FIG. 2 is a side view of the fuel filtration system of the fuel delivery system of FIG. 1.

FIG. 3 is a perspective view of the automatic drain assembly is shown of the fuel delivery system of FIG. 1.

FIG. 4 is a cross-sectional view of the automatic drain assembly of FIG. 3.

FIG. 5 is a close-up cross-sectional view of the automatic drain assembly of FIG. 3.

FIG. 6 is a cross-sectional view of the fuel filtration system of FIG. 2.

FIG. 7 is a flow diagram of a method of automatically draining water separated from fuel by a fuel filtration system via an automatic drain assembly is described according to an exemplary embodiment

### DETAILED DESCRIPTION

Referring generally to the figures, a fuel filtration system is described that includes an automatic drain assembly for water that accumulates in the filter housing. The filtration system includes a filter media that is configured to remove particulate matter and dispersed water contained within the fuel. The water is drained to a drain reservoir within the filter housing where the water collects. When the water reaches a threshold level, a controller initiates a warning to the engine operator, such as by illuminating a dashboard light, that instructs the operator to shut the engine off. When the engine is shut off, the collected water is drained through an electrically actuated valve, e.g., a solenoid valve, of the automatic drain assembly. In some arrangements, the automatic drain assembly can be retrofitted to existing fuel filtration systems, thereby reducing the cost of fitting the automatic drain assembly to existing internal combustion engines.

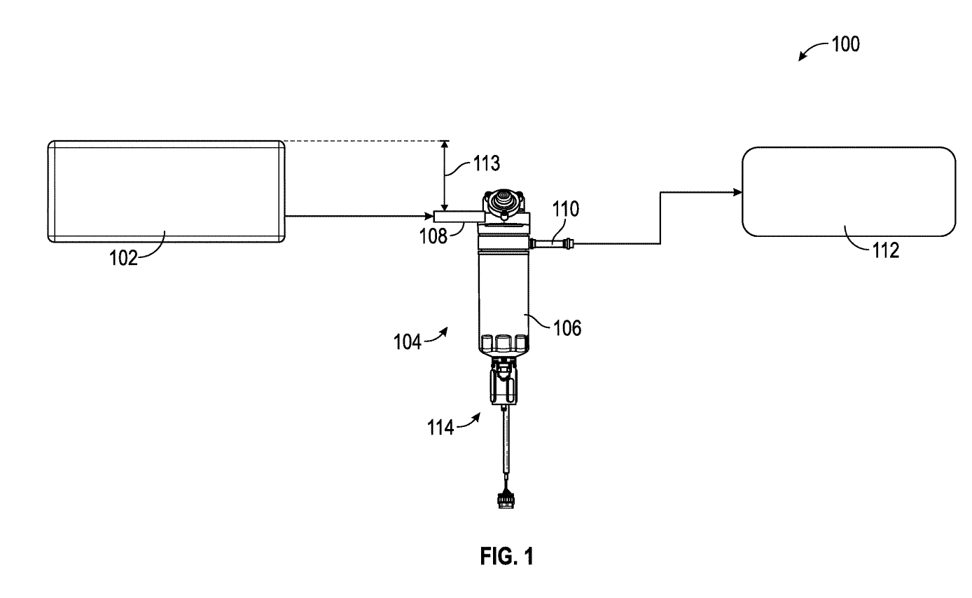

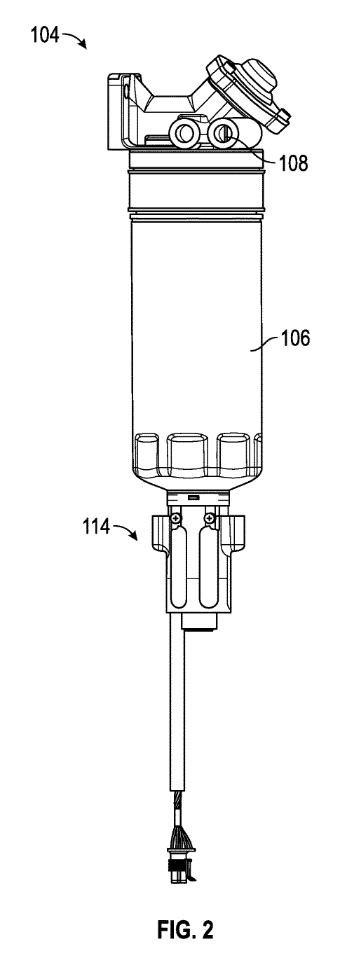

Referring to FIG. 1, a schematic overview of a fuel delivery system 100 is shown according to an exemplary embodiment. The fuel delivery system 100 includes a fuel tank 102 in fluid communication with a fuel filtration system 104. FIG. 2 shows a side view of the fuel filtration system 104. The fuel filtration system 104 includes a fuel filter housing 106, a fuel inlet 108, and a fuel outlet 110. The fuel filter housing 106 includes a filter element configured to remove particulate matter from fuel and configured to coalesce and remove water from the fuel. Fuel to be filtered flows from the fuel tank 102 into the fuel filter housing 106 via the inlet 108. The fuel flows through the filter media, where the fuel is filtered. The fuel flows out of the housing via the fuel outlet 110. In some arrangements, a suction pump 112 is used to create a pressure differential between the inlet 108 and the outlet 110, thereby pumping the fuel from the tank 102 and through the filter assembly 104. A check valve may be coupled to the fuel inlet 108, the check valve preventing fuel from flowing back into the fuel tank 102 from the fuel filter housing 106. The check valve ensures proper operation of the fuel filtration system 100 when the pressure differential is applied by the suction pump 112. In some arrangements, the pressure drop caused by the check valve is less than three kilopascals, although other pressure drops are also possible. The top of the fuel tank 102 is higher than the fuel inlet 108 by a distance 113. In some arrangements, the distance 113 is greater than zero and less than thirty-five centimeters, although other distances are also possible. The filter assembly 104 further includes an automatic drain assembly 114 that periodically drains water separated from the fuel that collects within the fuel filter housing 106 (e.g., to a drain reservoir positioned at a bottom of the fuel filter housing 106). The arrangement and operation of the automatic drain assembly 114 is described in further detail below.

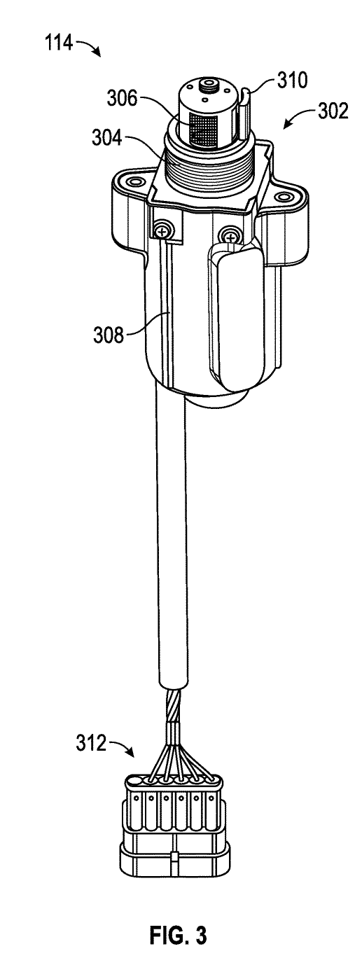

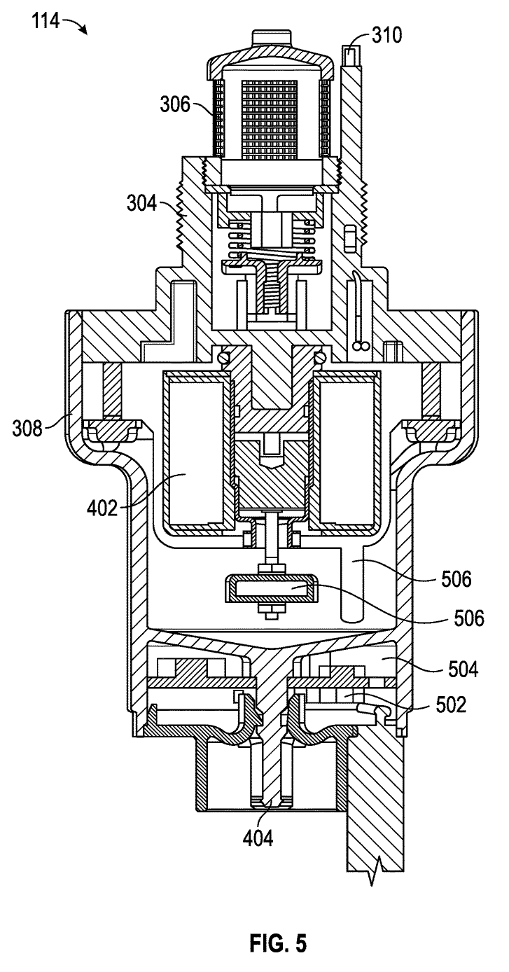

Referring to FIG. 3, a perspective view of the automatic drain assembly 114 is shown. As shown in FIG. 3, the automatic drain assembly 114 is removed from the fuel filter housing 106. The automatic drain assembly includes a top end 302 having a threaded connector 304. The threaded connector 304 is configured to removably couple the automatic drain assembly 114 to the fuel filter housing 106 by connecting to a mating threaded connector on the bottom end of the fuel filter housing 106. The top end 302 also includes a water inlet 306 that extends into the fuel filter housing 106 when the automatic drain assembly 114 is coupled to the fuel filter housing 106. The water inlet 306 allows water to drain from the fuel filter housing 106 and into the drain assembly housing 308. The top end 302 further includes water in fuel (“WIF”) pins 310 that extend into the fuel filter housing 106 when the automatic drain assembly 114 is coupled to the fuel filter housing 106. The WIF pins 310 are part of a WIF sensor. The WIF pins 310 are used by a controller 502 (as shown in FIG. 5) of the automatic drain assembly 114 to determine when the water level within the fuel filter housing 106 reaches a threshold level (e.g., the height of the WIF pins 310). The automatic drain assembly 114 further includes a wire harness 312. The wire harness 312 connects the controller 502 of the automatic drain assembly 114 to the engine control unit (“ECU”). The wire harness 312 provides for data communication between the controller 502 of the automatic drain assembly 114 and the ECU. Additionally, the wire harness 312 provides electrical power (e.g., from the battery or alternator of the internal combustion engine via the ECU) to the controller 502 and the components of the automatic drain assembly 114. The electrical power provided from the battery of the internal combustion engine may be used to charge a drain assembly battery that is used to power the controller and the valve during a drainage cycle when the internal combustion engine is off. In some arrangements, the wire harness 312 provides the voltage of the key-switch of the internal combustion engine. Based on the voltage reading of the key-switch, the controller 502 can determine whether the internal combustion engine is on or off.

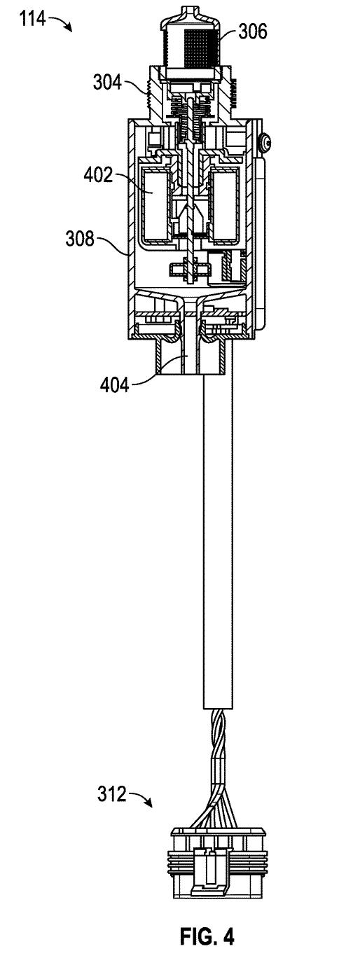

FIG. 4 shows a cross-sectional view of the automatic drain assembly 114. FIG. 5 shows a close-up cross-sectional view of the automatic drain assembly 114. As shown in FIGS. 4 and 5, the automatic drain assembly 114 includes a solenoid valve 402 coupled to the drain assembly housing 308. It should be noted that, while a solenoid valve is specifically discussed herein, other types of electrically-actuated valves, such as piezoelectric valves, could also be used. The solenoid valve 402 is normally biased to a closed position (e.g., a position in which water cannot flow past the solenoid valve). The solenoid valve 402 is opened when an electrical current is provided to the solenoid valve by the controller 502. The solenoid valve 402 is periodically opened by the controller 502 to drain separated water from the fuel filter housing 106. When the solenoid valve 402 is opened, water flows from the fuel filter housing 106, through the water inlet 306, into the drain assembly housing 308, and out of the drain assembly housing 308 via a drain opening 404. The drain opening 404 may be open to the ambient environment or coupled to a water storage tank. In some arrangements, the solenoid valve 402 is integrated with the WIF sensor and the WIF pins 310.

The controller 502 is coupled to the drain assembly housing 308 such that the controller 502 and the solenoid valve 402 are integrated into a single component. As shown in FIG. 5, the controller 502 is positioned in a compartment 504 of the drain assembly housing 308 that is isolated from the water that drains through the drain assembly housing 308. The controller 502 may be an integrated control circuit on a printed circuit board. The controller 502 periodically opens and closes the solenoid valve 402 based at least in part on a WIF feedback signal from the WIF sensor and feedback from the ECU (e.g., a signal indicating that the internal combustion engine is off) via the wiring harness 312. Because the solenoid valve 402 and the controller 502 are integrated within the drain assembly housing 308, no additional wiring harness is needed other than the wiring harness 312. The controller 502 also receives a position feedback signal from a position sensor 506. In some arrangements, the position sensor 506 is integrated into the solenoid valve 402. The position sensor 506 provides a feedback signal to the controller 502 indicative of the position of the solenoid valve 402 (e.g., whether the solenoid valve is open, closed, ajar, etc.). The position sensor 506 allows the controller 502 to determine whether the solenoid valve 402 opened and closed properly during a drainage cycle. Additionally, the position sensor 506 can provide an indication to the controller 502 that the circuit between the solenoid valve 402 and the controller 502 is broken if the solenoid valve 402 is not moving as instructed by the controller 502.

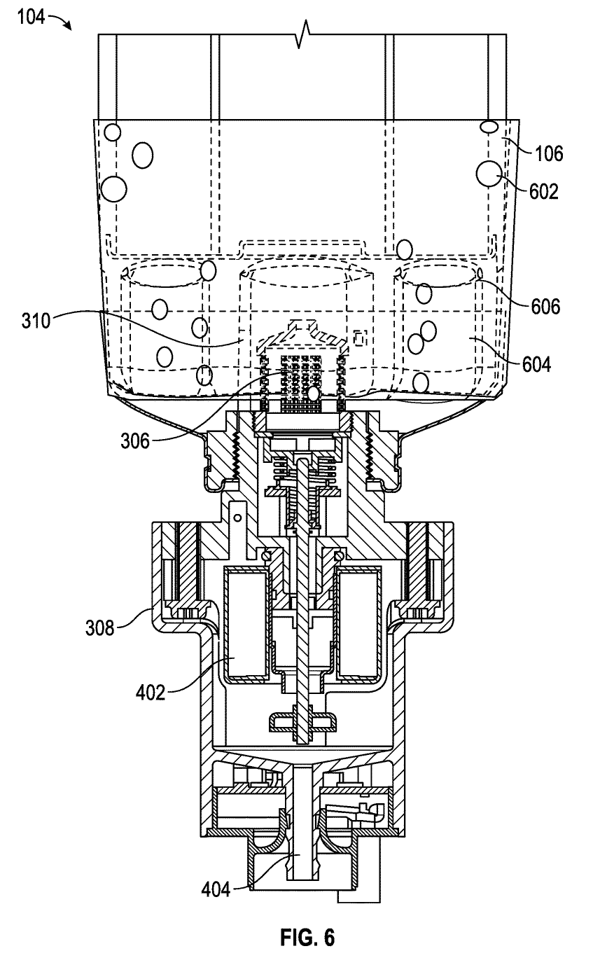

The controller 502 controls the operation of the solenoid valve 402 automatically (i.e., without direct instruction from an operator of the internal combustion engine). Once the height of the water within the fuel filter housing 106 reaches the WIF pins 310, the controller 502 will automatically drain the collected water after the internal combustion engine is powered down. For example, as shown in FIG. 6, the fuel filtration system 104 having the automatic drain assembly 114 installed in the operating position is shown. As the water droplets 602 fall to the bottom of the fuel filter housing 106, the level of water 604 rises until it reaches the WIF pins 310 of the WIF sensor. Once the water 604 reaches the height of the WIF pins 310 within the fuel filter housing 106, the drainage cycle will be automatically initiated once the internal combustion engine is shut down. There is no need for an operator to press a button or perform another form of manual actuation that manually triggers the solenoid valve 402. In particular implementations, the water draining process takes approximately thirty seconds from engine shutdown to completion. If the controller 502 receives an indication from the position sensor 506 that the solenoid valve 402 has not closed properly (e.g., is stuck in the open position) after the drainage cycle, the controller 502 can send another open instruction to “click” the solenoid valve 402 by providing a quick flow of current to the solenoid valve 402 that quickly opens and closes the solenoid valve 402. The controller 502 can repeat the “click” command that causes the solenoid valve 402 to “click” a designated number of times prior to the solenoid valve 402 powering down.

The above-described automatic drain assembly 114 can replace a manual drain assembly of an existing fuel filtration system. Accordingly, the automatic drain assembly 114 is an independent part that can be retrofitted to existing fuel filtration systems by screwing the automatic drain assembly 114 to the bottom of the existing fuel filtration housing (e.g., as described above with respect to the fuel filter housing 106). The wire harness 312 can connect to existing electrical connection ports on the ECU of the engine having the existing fuel filtration system. Because the automatic drain assembly 114 can be a retrofit part, older fuel filtration systems can be updated to have an automatic drain feature without the added expense or complex service of replacing the entire fuel filtration system. In some arrangements, the retrofit may require a new connector to properly receive the drain assembly 114, however, the connector is still less expensive than replacing the entire fuel filtration system. Further, the above-described automatic drain assembly does not require manual input or a special tool (e.g., such as a special valve opening tool) to initiate a drainage cycle.

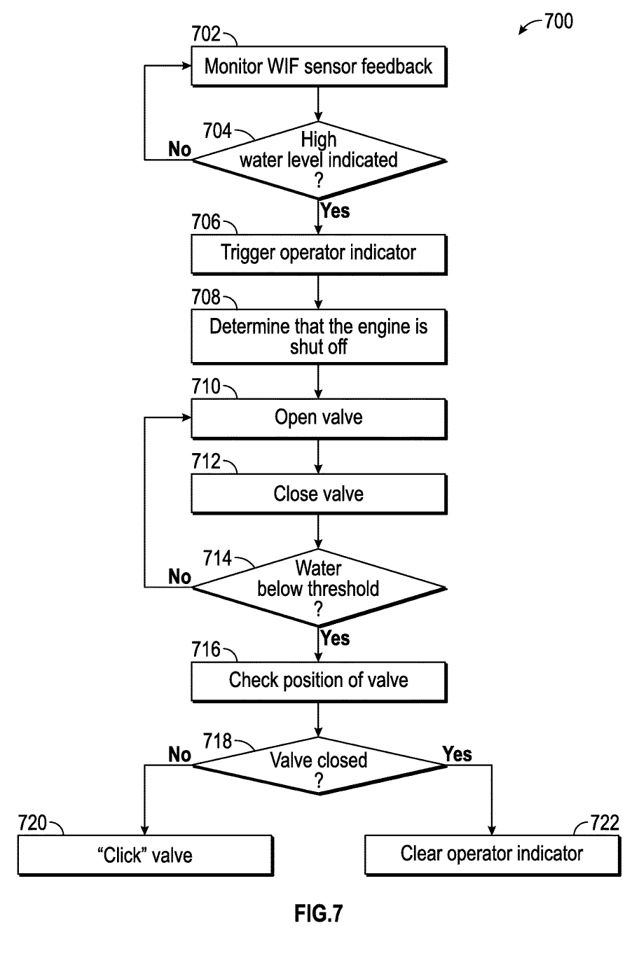

Referring to FIG. 7, a flow diagram of a method 700 of automatically draining water separated from fuel by a fuel filtration system (e.g., fuel filtration system 100) via an automatic drain assembly (e.g., automatic drain assembly 114) is described according to an exemplary embodiment. The method 700 begins when the WIF sensor is monitored (702). The WIF sensor (e.g., WIF pins 310) is monitored by a controller (e.g., controller 502) of the automatic drain assembly. During operation of an internal combustion engine, the fuel filtration system filters fuel to be combusted by the internal combustion engine. The fuel filtration system removes water that may be dispersed within the fuel during the fuel filtration. The water accumulates at the bottom of the filter assembly housing (e.g., fuel filter housing 106). The WIF sensor is positioned to detect a threshold level of accumulated water within the filter assembly housing. The controller determines whether a high water level is indicated by the WIF sensor (704). The high water level relates to the threshold level of accumulated water within the filter assembly housing. If a high water level is not indicated, the controller continues to monitor the WIF sensor (at 702) until a high water level is indicated.

If a high water level is determined, the controller triggers an operator indicator (706). The controller is in communication with the ECU of the internal combustion engine. The controller can send an error code to the ECU to trigger the operator indicator. The operator indicator may be a dashboard light or a display message. For example, the operator indicator may be a dashboard light that displays “DRAIN WATER” or a similar message. The operator indicator alerts the operator that the internal combustion engine should be shut off so that the automatic drain assembly can properly drain the separated water from the fuel assembly housing. The controller determines that the internal combustion engine has been shut off (708). In some arrangements, the controller determines that the internal combustion engine is off based on a voltage reading of the key-switch. In other arrangements, the controller receives the indication that the internal combustion engine has been shut off from the ECU. The ECU prevents the operator from restarting the engine until the controller informs the ECU that the water has been drained (as discussed below at 722).

After the controller determines that the internal combustion engine was shut off, the controller opens a valve (710). The valve may be the solenoid valve 402. When the valve is opened, separated water is allowed to flow from the filter assembly housing into the drain assembly housing (e.g., drain assembly housing 302), and out of a drain (e.g., drain 404) in the drain assembly housing. After a designated period of time, the controller closes the valve (712). The controller determines whether the water level has fallen below a threshold water level (e.g., based on a feedback signal from the WIF sensor) (714). If the water level has not fallen below the threshold water level, the controller returns to 712 and opens the valve. In some arrangements, the controller does not loop between 710 and 714. In one such arrangement, the controller closes the solenoid when the WIF sensor no longer detects a high water level. In another such arrangement, the controller closes the valve after a predetermined time period once the water level falls below the WIF sensor pins, which allows the water to drain below the high water level. In such an arrangement, process 714 does not exist, and if the water does not fall below the high water level, the alarm will resound when the internal combustion engine is restarted, and method 700 will begin from the start.

After the valve has been closed and the water level has fallen below the threshold, the controller checks the position of the valve (716). The valve may have an integrated position sensor (e.g., position sensor 506). The position sensor provides a feedback signal to the controller indicative of the position of the valve. During some drainage cycles, the valve may close improperly (e.g., remain slightly open despite power not being provided to the valve). Based on the feedback signal from the position sensor, the controller determines whether the valve is properly closed (718). If the valve is not properly closed, the controller “clicks” the valve (720). The controller clicks the valve by providing a quick flow of current to the valve that quickly opens and closes the valve. The valve “clicks” for a predetermined number of clicks before powering off. Once the valve is properly closed, the controller sends a signal to the ECU to clear the operator indicator (722). The ECU clears the operator indicator, and the operator is permitted to restart the internal combustion engine.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or resequenced according to alternative embodiments. Other substitutions, modifications, changes and omissions may also be made in the design, operating conditions and arrangement of the various exemplary embodiments without departing from the scope of the present invention.

What is claimed is:

1. A fuel filtration system configured to provide filtered fuel to an internal combustion engine, the fuel filtration system comprising:
a filter housing including an inlet, an outlet, a filter media, and a drain reservoir positioned at a bottom of the filter housing; and
an automatic drain assembly removably coupled to the filter housing, the automatic drain assembly comprising:
a drain assembly housing,
a water inlet that extends into the filter housing,
a valve coupled to the drain assembly housing,
a water in fuel sensor coupled to the valve, and
a controller configured to open and close the valve based at least in part on a water in fuel feedback signal of the water in fuel sensor without direct instruction from an operator of the internal combustion engine.

2. The fuel filtration system of claim 1, wherein the automatic drain assembly is removably coupled to the filter housing via a threaded connection.

3. The fuel filtration system of claim 1, wherein the automatic drain assembly further comprises a wire harness configured to provide data communication between the controller and an engine control unit of the internal combustion engine.

4. The fuel filtration system of claim 3, wherein the wire harness is configured to provide electrical power to the controller from a battery of the internal combustion engine.

5. The fuel filtration system of claim 3, wherein the wire harness provides a voltage of an engine key-switch of the internal combustion engine to the controller.

6. The fuel filtration system of claim 1, wherein the valve comprises a solenoid valve.

7. The fuel filtration system of claim 1, wherein the valve is integrated with the water in fuel sensor.

8. The fuel filtration system of claim 1, wherein the automatic drain assembly further comprises a position sensor configured to provide a position sensor feedback signal to the controller indicative of a position of the valve.

9. The fuel filtration system of claim 8, wherein the valve is integrated with the position sensor.

10. The fuel filtration system of claim 8, wherein the controller is configured to click the valve by providing a quick flow of current to the valve that quickly opens and closes the valve, if the position feedback signal indicates that the valve has not closed properly after a drainage cycle.

11. The fuel filtration system of claim 1, further comprising a suction pump coupled to the outlet, the suction pump configured to create a pressure differential between the inlet and the outlet, thereby pumping fuel into the inlet from a fuel tank.

12. The fuel filtration system of claim 1, further comprising a check valve coupled to the inlet, the check valve preventing fuel from flowing back into the fuel tank.

13. An automatic drain system for a fuel filtration system of an internal combustion engine, the automatic drain system comprising:
a drain assembly housing,
a water inlet configured to extend into a filter housing of the fuel filtration system,
a valve coupled to the drain assembly housing,
a water in fuel sensor coupled to the valve, and
a controller configured to open and close the valve based at least in part on a water in fuel feedback signal of the water in fuel sensor without direct instruction from an operator of the internal combustion engine.

14. The automatic drain system of claim 13, wherein the drain assembly housing is configured to be removably coupled to the filter housing via a threaded connection.

15. The automatic drain system of claim 13, further comprising a wire harness configured to provide data communication between the controller and an engine control unit of the internal combustion engine.

16. The automatic drain system of claim 15, wherein the wire harness is configured to provide electrical power to the controller from a battery of the internal combustion engine.

17. The automatic drain system of claim 15, wherein the wire harness provides a voltage of an engine key-switch of the internal combustion engine to the controller.

18. The automatic drain system of claim 13, wherein the valve is integrated with the water in fuel sensor.

19. The automatic drain system of claim 13, further comprising a position sensor configured to provide a position sensor feedback signal to the controller indicative of a position of the valve.

20. The automatic drain system of claim 19, wherein the valve is integrated with the position sensor.

21. The automatic drain system of claim 19, wherein the controller is configured to click the valve by providing a quick flow of current to the valve that quickly opens and closes the valve if the position feedback signal indicates that the valve has not closed properly after a drainage cycle.

22. The automatic drain system of claim 13, wherein the valve comprises a solenoid valve.

23. A method of automatically draining water separated from fuel by a fuel filtration system of an internal combustion engine via an automatic drain assembly, the method comprising:
monitoring, by a controller of the automatic drain assembly, a water in fuel sensor of the automatic drain assembly;
determining, by the controller, that a high water level exists within a filter assembly housing of the fuel filtration system;
opening, by the controller, a valve of the automatic drain assembly without direct instruction from an operator of the internal combustion engine, wherein when the valve is open, the water is allowed to drain out of the filter assembly housing through a drain of a drain assembly housing; and
closing, by the controller, the valve.

24. The method of claim 23, further comprising sending, by the controller, an error code to an engine control unit of the internal combustion engine, wherein the error code triggers an operator indicator.

25. The method of claim 24, wherein the operator indicator is a dashboard light.

26. The method of claim 23, further comprising determining, by the controller, that the internal combustion engine was shut off prior to opening the valve.

27. The method of claim 23, further comprising determining, by the controller, that the valve did not close properly based on a feedback signal from a position sensor.

28. The method of claim 27, further comprising clicking, by the controller, the valve by providing a quick flow of current to the valve that quickly opens and closes the valve.

29. The method of claim 23, wherein the valve comprises a solenoid valve.
